(19) United States
(12) Patent Application Publication
(10) Pub. No.: US 2023/0026653 A1
(43) Pub. Date: Jan. 26, 2023

(54) TRANSMIT AND RECEIVE CHANNEL SWAP FOR INFORMATION HANDLING SYSTEMS,

(71) Applicant: Dell Products L.P., Round Rock, TX (US)

(72) Inventors: Timothy M. Lambert, Austin, TX (US); Bhyrav Murthy Mutnury, Austin, TX (US); Sandor Farkas, Round Rock, TX (US)

(73) Assignee: Dell Products L.P., Round Rock, TX (US)

(21) Appl. No.: 17/443,125

(22) Filed: Jul. 21, 2021

(51) Int. Cl. G06F 13/20; G06F 13/42; G06F 13/40

(52) U.S. Cl. CPC G06F 13/20; G06F 13/4282; G06F 13/4022; G06F 2213/0026

(57) ABSTRACT

An apparatus includes an interface with a plurality of channels; a multiplexer coupled to the interface and configured to couple transmit circuitry to a first channel mapped as a transmit path in a channel configuration and to couple receive circuitry to a second channel mapped as a receive path in the channel configuration; and a controller coupled to the multiplexer. The controller may be configured to perform the steps including determining a figure of merit of at least one channel of the plurality of channels of the interface; determining the channel configuration mapping transmit and receive paths to the plurality of the channels of the interface; and controlling the multiplexer to couple transmit circuitry to the first channel mapped as a transmit path in the channel configuration and to couple receive circuitry to the second channel mapped as a receive path in the channel configuration for dynamic channel swap(s).

### FIELD OF THE DISCLOSURE

The instant disclosure relates to dynamic transmit and receive channel swap for an information handling system. More specifically, portions of this disclosure relate to dynamic transmit and receive channel swap for improved high-speed signaling.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include data channels for communicating between components of the information handling system. Faster components that process more data in shorter durations of time also may transfer more data in shorter durations to other components. The clock frequencies on the data channels are increased to support higher data throughput. Small errors in the manufacturing of the channels that may have little effect on the data at low frequencies may degrade performance at high frequencies, such that the manufacturing tolerances for the channels decreases.

Shortcomings mentioned here are only representative and are included to highlight problems that the inventors have identified with respect to data transmission in information handling systems (IHSs) and sought to improve upon. Aspects of the system with one or more features described below may address some or all of the shortcomings as well as others known in the art.

### SUMMARY

Data channels between components in an information handling system may be referred to as north-bound channels or south-bound channels referring to whether the channels are inputs to the component or outputs from the component. Despite care taken during design to route signals for north- and south-bound properly, increasing signal speeds and tighter margins are constant issues. Design considerations based on factors such as silicon differences, physical channels, process, voltage, & temperature (PVT), and tolerances, alone or in combination, may not rectify the signal integrity issues. The receiver margin at components, such as a root-complex or end-device, may be drastically different, or the sensitivity of one component may be different than another component resulting in differences in signal strengths between the various lanes. For example, the configuration of a particular information handling system, including what components are installed, may affect what data is transferred over the various channels between the components. In some embodiments, each of these channels are conducting pathways between components coupled to a motherboard, such as when the channels are printed circuit board (PCB) traces through the motherboard, although the channels may also include or alternatively be other conductors such as wires, jumper cables, ribbon cables, or optical cables. Different channels may be routed through different layers of the PCB resulting in different signal characteristics of the channels.

One or more figures of merit of the channels may be determined and used to determine a channel configuration specifying a first channel as a north-bound or input channel and a second channel as a south-bound or output channel. The channel configuration may be determined during operation of the information handling system, such as during a device boot-up, such that conditions of the channels and components in the information handling system may be accommodated. For example, each channel coupled to an interface of a component may be measured in both directions and the channel configuration assigned to use channels that provide the highest data transfer rates for the component. A multiplexer in a component coupled to the channels may be used to swap transmit and receive circuitry between channels based on the determined figure of merit. The figures of merit may include a physical bit error rate, a margin measurement, signal timing, or a sensitivity of a channel including the receiver. The system may consider the receiver sensitivities in the system and swap the transmit and receive channel to optimize the channel margins. By taking the receiver sensitivities into account, the system may determine that the adapter cards are not identical and that the routing of channels through multiple layers of the PCB result in the channels having different characteristics.

A controller (e.g., a BIOS and/or BMC) may control muxes within one or more components of an information handling system to perform channel swaps after determining a channel configuration through any number of algorithms. In one example, the controller may walk each channel through each lane direction while performing measurements on the channels to discover an optimal signal integrity before or after link training and determining a channel configuration based on the lane tests. In another example, the controller may use a trained machine learning (ML) by inputting information (e.g., measurement of figures of merits, device information, and/or channel physical characteristics) to the ML model and determining a channel configuration based on the ML model.

According to some embodiments, a method may include determining, by an information handling system, a first figure of merit of at least one channel of a plurality of channels coupled to an interface; determining, by the information handling system based on the first figure of merit, a channel configuration mapping transmit and receive paths to the plurality of channels of the interface; and/or controlling, by the information handling system based on the channel configuration, a multiplexer to couple transmit circuitry to a first channel mapped as a transmit path in the channel configuration and to couple receive circuitry to a second channel mapped as a receive path in the channel configuration.

The method may include controlling the multiplexer to couple a driver of the transmit circuitry to a first terminal directly connected to the first channel, controlling the multiplexer to couple transmit circuitry to the first channel and to couple receive circuitry to the second channel is performed before link training, controlling a multiplexer coupling a central processing unit (CPU) to the first channel and the second channel, and wherein controlling the second multiplexer by the BMC comprises controlling a peripheral component interconnect express (PCIe) device, and/or determining the channel configuration mapping transmit and receive paths to the plurality of the channels of the interface based on at least one of a physical bit error rate, a margin measurement, a signal timing, a signal-to-noise ratio (SNR), a bathtub measurement, an Eye-diagram characteristics, or a sensitivity of the first channel.

The method may further include controlling, by a BIOS through a baseboard management controller (BMC) of the information handling system, a second multiplexer at an endpoint device coupled to the first channel and the second channel based on the channel configuration. According to some embodiment, an apparatus may include an interface configured to couple to a plurality of channels; a multiplexer coupled to the interface and configured to couple transmit circuitry to a first channel mapped as a transmit path in a channel configuration and to couple receive circuitry to a second channel mapped as a receive path in the channel configuration; and/or a controller coupled to the multiplexer. The controller may be configured to perform steps of methods described herein. For example, the controller may be configured to perform steps comprising determining, by an information handling system, a first figure of merit of at least one channel of a plurality of channels coupled to an interface, determining, by the information handling system based on the first figure of merit, a channel configuration mapping transmit and receive paths to the plurality of channels of the interface, controlling, by the information handling system based on the channel configuration, a multiplexer to couple transmit circuitry to a first channel mapped as a transmit path in the channel configuration and to couple receive circuitry to a second channel mapped as a receive path in the channel configuration. In embodiments of the apparatus, the first channel and the second channel may comprise a first set of channels and a second set of channels, wherein the first set of channels and the second set of channels are coupled by an I/O switch based on the transmit path and the receive path, the interface may comprise a package terminal array, the controller may be a basic input/output system (BIOS), the apparatus may include a central processing unit (CPU) and the second multiplexer is part of a peripheral component interconnect express (PCIe) device.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. For example, the dynamic transmit and receive channel swap may be implemented in any of the embodiments of the disclosure. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed method, apparatus, and information handling system, reference is now made to the following descriptions taken in conjunction with the accompanying drawings.

FIG. 1A is a block diagram of a system according to some embodiments of the disclosure.

FIG. 1B is a block diagram of a system according to some embodiments of the disclosure.

FIG. 2 is flow chart illustrating a method according to some embodiments of the disclosure.

FIG. 3 is a block diagram of a system according to some embodiments of the disclosure.

FIG. 4A is a sequence flow diagram of the system according to some embodiments of the disclosure.

FIG. 4B is a sequence flow diagram of the system according to some embodiments of the disclosure.

FIG. 5 is a schematic block diagram of an example information handling system according to some embodiments of the disclosure.

### DETAILED DESCRIPTION

Higher data rates and throughputs may be possible over channels by accounting for asymmetries in the channels between transmit and receive data paths. These asymmetries may be caused by, for example, manufacturing differences in the channels themselves and/or manufacturing differences in the components communicating on the channels. A multiplexer in a component coupled to the channels may be used to swap the transmit and receive circuitry of the component between the channels. Figures of merit may be used in swap logic to determine a channel configuration and a multiplexer configuration corresponding to the channel configuration. The figures of merit may include a physical bit error rate, a margin measurement, signal timing, and/or a sensitivity of a channel including the receiver. The system may determine the optimal channels for signals to travel using the dynamic transmit and receive channel swap logic to instruct the multiplexers, cross bar, or other comparable component to couple the transmit (TX or TXD) and receive (RX or RXD) circuitry to the optimal channel(s). With a controller and the multiplexer, the system may determine when to implement channel swaps to change the channel configuration including the receiver(s), adapter card(s), and/or other components. By taking the channel and receiver sensitivities into account, the system may improve the signal integrity by optimizing the transmit and receive paths for communication.

Example embodiments describe and illustrate various functions of an information handling system. In some embodiments, the apparatus may include the information handling system, wherein the first channel and the second channel are part of a peripheral component interface (PCI) bus. The PCI bus may be used to couple, for example, a processor to a memory or a processor to a network interface card (NIC). Additionally, the peripheral component interface (PCI) bus may include a plurality of channels and may be coupled to a multiplexer at each component that is configured to swap the transmit and receive channel.

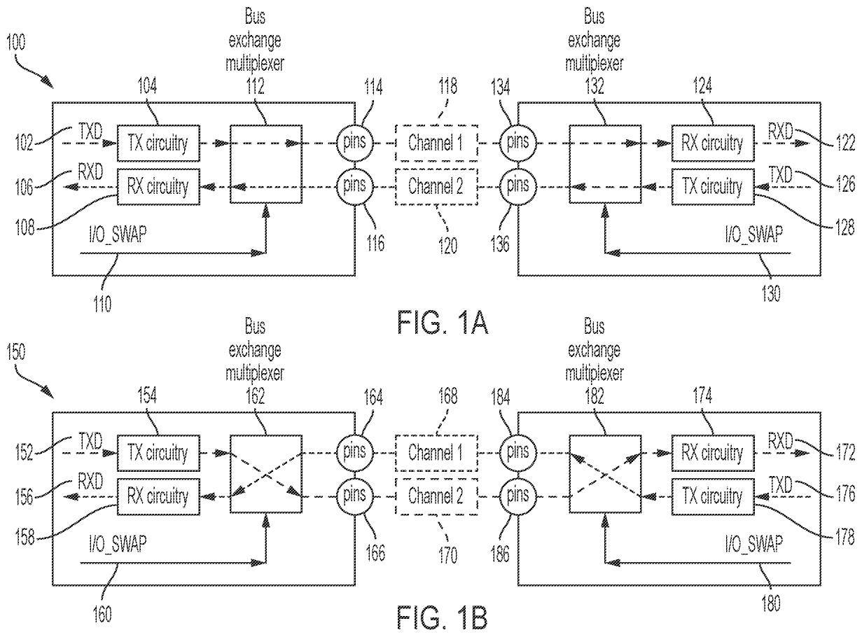

An information handling system may include a variety of components configured to swap the transmit and receive channel to transmit and receive information. FIG. 1A depicts a system 100 with two channels, channel 1 118 and channel 2 120. A bus may include channel 1 118 and channel 2 120. In some embodiments, the bus may include a peripheral component interface (PCI). The channels 118 and 120 may be coupled to the components at an interface, such as a package terminal array that includes pins, balls, or other connections. For example, channel 1 118 is coupled to pin 114 and pin 134 to transmit a TXD 102 signal from TX circuitry 104 through the bus exchange multiplexer 112 and bus exchange multiplexer 132 to the RX circuitry 124 as a RXD signal 122. Further, channel 2 120 is coupled to pin 116 and pin 136 to transmit a TXD 126 signal from TX circuitry 128 through the bus exchange multiplexer 112 and bus exchange multiplexer 132 to the RX circuitry 108 as a RXD signal 106.

The bus exchange multiplexer 112 and bus exchange multiplexer 132 may be coupled to the channels 118 and 120 through the interface pins 114, 116 and 134, 136, respectively. The multiplexers 112 and 132 may be configured to couple TX circuitry 104 or TX circuitry 128 to Channel 1 118 or Channel 2 120, respectively, to configure the transmit path. The bus exchange multiplexer 112 and bus exchange multiplexer 132 may be configured to couple RX circuitry 108 or RX circuitry 124 to Channel 1 118 or Channel 2 120, respectively, to configure a receive path. In some embodiments, the TX circuitry 104, TX circuitry 128, RX circuitry 108, and/or RX circuitry 124 may be included in a large single circuit or separate circuits. A controller may be coupled to the bus exchange multiplexer 112 or the bus exchange multiplexer 132 to control an I/O swap signal 110 for the bus exchange multiplexer 112 for the TX circuitry 104 or the RX circuitry 108 or an I/O swap signal 130 for the bus exchange multiplexer 132 for the TX circuitry 128 or the RX circuitry 124.

In certain embodiments, the bus exchange multiplexer 112 or the bus exchange multiplexer 132 may be an internal whole SerDes interface type MUX, which may provide interface options such as PCIe, Serial Advanced Technology Attachment (SATA), 10 gigabit media-independent interface (XGMII), unified payment interface (UPI), universal serial bus 3.0 (USB3), or other interface types. In another embodiment, the bus exchange multiplexer 112 or the bus exchange multiplexer 132 may be another comparable MUX for high-speed communications. FIG. 1A may also include storage for the controller to access information used in the logic to control the I/O swap signal 110 or I/O swap signal 130. For example, a basic input/output system (BIOS) and/or a baseband management controller (BMC) may store channel physical characteristics.

When the controller determines to control the bus exchange multiplexer 112 or the bus exchange multiplexer 132 with the I/O swap signal 110 or the I/O swap signal 180, respectively, the system 100 may be reconfigured as system 150 as shown in FIG. 1B. Channel 1 118 and channel 2 120 may include a first set of channels and a second set of channels. The first set of channels and the second set of channels may be coupled by an I/O switch, such as the bus exchange multiplexer 112 or the bus exchange multiplexer 132, based on the transmit path and the receive path specified in a channel configuration determined for the system 150. In another embodiment, Channel 1 118 and channel 2 120 may include a variable complex channel, multiple boards, cables, connectors, or another comparable component.

FIG. 1B depicts a system 150 with two channels, channel 1 168 and channel 2 170. Channel 1 168 is coupled to pin 164 and pin 184 to transmit a TXD 152 signal from TX circuitry 154 through the bus exchange multiplexer 162 and bus exchange multiplexer 182 to the RX circuitry 174 as a RXD signal 172. Channel 2 170 is coupled to pin 166 and pin 186 to transmit a TXD 176 signal from TX circuitry 178 through the bus exchange multiplexer 182 and bus exchange multiplexer 162 to the RX circuitry 158 as a RXD signal 156.

The bus exchange multiplexer 162 and bus exchange multiplexer 182 may be coupled to the interface and configured to couple TX circuitry 154 or TX circuitry 178 to Channel 1 168 or Channel 2 170, respectively, to configure the transmit path. The bus exchange multiplexer 162 and bus exchange multiplexer 182 may be coupled to the interface and configured to couple RX circuitry 158 or RX circuitry 174 to Channel 1 168 or Channel 2 170, respectively, to configure a receive path. In some embodiments, the TX circuitry 154, TX circuitry 178, RX circuitry 158, and/or RX circuitry 174 may be included in a large single circuit or separate circuits. A controller may be coupled to the bus exchange multiplexer 162 or the bus exchange multiplexer 182 to control an I/O swap signal 160 for the bus exchange multiplexer 162 for the TX circuitry 154 or the RX circuitry 158 or an I/O swap signal 180 for the bus exchange multiplexer 182 for the TX circuitry 178 or the RX circuitry 174.

The controller may determine a figure of merit of at least Channel 1 168, Channel 2 170, or another channel of the interface. For example, the controller may identify the figure of merit such as a physical bit error rate, a margin measurement, a signal timing, a signal-to-noise ratio (SNR), a bathtub measurement, or an eye-diagram characteristic. An eye-diagram characteristic may include signal timing, signal levels, and a measurement between differential pairs to predict headroom before failure. In another embodiment, the controller may identify netlist and static attributes of each signal and/or medium throughout the channel by collecting and analyzing attributes before the channel links are purposed or during the basic input/output system (BIOS) training phase with lane direction swaps occurring within to find the optimized channel configuration. In some embodiments, the controller may identify medium characteristics such as silicon design, layers, length, connector rows, or cable pinouts or may identify another characteristic of the channel such as the receiver sensitivity, another sensitivity, or channel capabilities in and/or out of band. For example, the channel capabilities in- and/or out-of-band may include PCI configuration space, or management component transport protocol (MCTP) over a system management bus (SMBUS) or via a vital product data (VPD) element.

Based on the figure of merit, the controller may determine the channel configuration mapping transmit and receive paths for Channel 1 168 or Channel 2 170. The channel configuration may include system 150 elements such as a high-speed communication device where the high speed channels are of interest. The apparatus may include an information handling system with the interface such as a peripheral component interface (PCI) bus, a processor, and a memory. In some embodiments, the peripheral connection interface (PCI) bus may include a plurality of channels such as x4, x8, or x16 PCIe connections. In some embodiments, the channel configuration may be based on information regarding a motherboard routing to a component or slot, basic input/output system (BIOS) configuration, a PCI Root Complex configuration, a PCIe Endpoint Device configuration, a management entity configuration, and/or attributes of each board, cable, and connector throughout the channel.

The controller may control the bus exchange multiplexer 162 with the I/O swap 160 to couple TX circuitry 162 to pin 166 instead of pin 164 or the bus exchange multiplexer 182 with I/O swap 180 to couple TX circuitry 176 to pin 184 instead of pin 186 to form a transmit path. The controller may also control the bus exchange multiplexer 162 to couple RX circuitry 158 to pin 164 instead of pin 166 or the bus exchange multiplexer 182 to couple RX circuitry 174 to pin 186 instead of pin 184 to form a receive path. Depending on the mapped channel configuration based on the figure of merit, Channel 1 168 may have the TXD signal 176 travel through the TX circuitry 178 through the bus exchange multiplexer 182, the pin 184, the pin 164, the bus exchange multiplexer 162, and the RX circuitry 158 as the RXD signal 156. Additionally, Channel 2 170 may have the TXD signal 152 travel through the TX circuitry 154 through the bus exchange multiplexer 162, the pin 166, the pin 186, the bus exchange multiplexer 182, and the RX circuitry 174 as the RXD signal 172. In some embodiments, controlling the bus exchange multiplexer 162 or the bus exchange multiplexer 182 to couple the TX circuitry 154 or the TX circuitry 178 may include coupling a driver of the TX circuitry 154 or the TX circuitry 178, respectively, to a terminal directly connected to either Channel 1 168 or Channel 2 170. For example, an I/O bus exchange multiplexer such as the bus exchange multiplexer 162 or the bus exchange multiplexer 182 may be inserted between the driver and pin on both ends in silicon without intervening components, which may alter the characteristics of the channel.

For control, the system 150 may implement logic such as I/O swap 160 and I/O swap 180. For example, the controller may implement the logic for swapping the transmit and receive paths using the bus exchange multiplexer 162 or the bus exchange multiplexer 182. I/O swap 160 and I/O swap 180 may be independently controlled by the controller so that pins 164, 166, 184, and 184 may be swapped to find an optimized channel for the transmit and receive signals such as the TXD signal 152 and the RXD signal 172. For example, independently controlling the bus exchange multiplexer 162 or the bus exchange multiplexer 182 may allow the controller to determine the channel configuration mapping based on the figure of merit to identify adequate channel margins. In certain embodiments, the logic may include programmable rules and/or an algorithm such as a machine learning algorithm. For example, the system 150 may identify and analyze the figure of merit in a loop at boot up or another time to determine the optimal channel configuration. The algorithm may occur in auxiliary mode, during boot up before the PCI enumeration phase, or at another time. The timing of the I/O swap 160 or the I/O swap 180 may be designed to account for different systems. When silicon warms up, the system 150 may change, and identifying a figure of merit such as the physical bit error rate, margin reads, secret registers, or other merit may indicate a system issue. The controller in system 150 may orchestrate the I/O swap 160 or the I/O swap 180 to prevent system instability.

The I/O swap 160 or the I/O swap 180 may be implemented before link training or changed during training to determine the channel configuration for signal integrity. In some embodiments, the I/O swap 160 or the I/O swap 180 may be implemented during link repurposing after initialization or during initialization. The controller may include the basic input/output system (BIOS) and/or the baseboard management controller (BMC). For the basic input/output system (BIOS), the basic input/output system (BIOS) may, during a link training sequence, control the I/O swap 160, I/O swap 180, and the BMC. For example, the basic input/output system (BIOS) may alter the channel swaps, such as the I/O swap signal 160 or the I/O swap signal 180, through any number of algorithms to determine the optimal signal integrity of the trained parameters. In another configuration, the basic management controller (BMC) may be included in the link training sequence and control the I/O swap 160, I/O swap 180, and the basic input/output system (BIOS). In other embodiments, the controller may be a complex programmable logic device (CPLD) or channel swap controlling entity. When the basic input/output system (BIOS), baseboard management controller (BMC), or another type of controller controls the I/O swap signal 160 or I/O swap signal 180, the controller may consider a different figure of merit that may be identified by the controller.

The system 150 may determine the I/O swap signal 160 and the I/O swap signal 180 before link training to avoid a potential driver contention in a channel configuration. For example, the controller may couple at least one transmit circuitry such as TX circuity 154 and one receive circuitry such as RX circuitry 174 using the bus exchange multiplexer 162, the bus exchange multiplexer 182, a cross bar, or other component. When the system 150 wants to swap the transmit and receive path without the bus exchange multiplexer 162, the bus exchange multiplexer 182, or the cross bar, the controller may orchestrate a break-before-make order to prevent system instability. FIG. 1B may also include storage for controller to access information used in the logic to control the I/O swap 110 or I/O swap 130. For example, the basic input/output system (BIOS) may store the full channel physical characteristics along with another component such as the basic management controller (BMC).

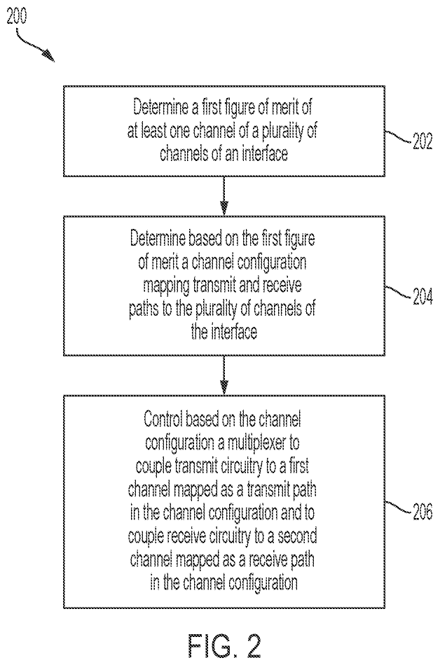

A controller may implement the steps as shown in FIG. 2 that illustrates a flow chart for a method according to some embodiments of the disclosure. In some embodiments, a processor may perform the steps of the method 200. In some embodiments, the controller may include a basic input/output system (BIOS), a baseboard management controller (BMC), or a comparable component to control a multiplexer. Method 200 includes block 202 for determining, by a system, a figure of merit of at least one channel of a plurality of channels coupled to an interface. In some embodiments, the interface may include a connection to a peripheral component interface (PCI).

For the figure of merit, the system may identify channel characteristics such as a physical bit error rate, a margin measurement, a signal timing, a signal-to-noise ratio (SNR), a bathtub measurement, or an eye-diagram characteristic. In some embodiments, the channel characteristics may include netlist and static attributes of each signal and/or medium throughout the channel before the channel links are purposed or during the basic input/output system (BIOS) training phase with lane direction swaps occurring within to find the optimized channel configuration. In some embodiments, the channel characteristics may include medium characteristics such as silicon design, layers, length, connector rows, or cable pinouts or another characteristic of the channel such as the receiver sensitivity, another sensitivity, or channel capabilities in and/or out of band. For example, the channel capabilities in- and/or out-of-band may include PCI configuration space, or management component transport protocol (MCTP) over a system management bus (SMBUS) or via a vital product data (VPD) element.

At block 204, the system may determine the channel configuration mapping transmit and receive paths to the plurality of the channels of the interface based on the figure of merit. The channel configuration may include system characteristics, and the channel configuration mapping may include the transmit path(s) and/or receive path(s). For example, the system may be an information handling system with the interface such as a peripheral component interface (PCI) bus, x4 PCIe connections, and a processor to determine the four transmit paths and receive paths. In some embodiments, the peripheral component interface (PCI) bus may include a plurality of channels such as x8 or x16 PCIe connections. The channel configuration may be based on a priori information describing a motherboard routing to a component or slot and channels coupled thereto.

The controller in the system at block 206 may control, based on the channel configuration, a multiplexer to couple transmit circuitry to a first channel mapped as a transmit path in the channel configuration and to couple receive circuitry to a second channel mapped as a receive path in the channel configuration. In some embodiments, controlling the multiplexer to couple transmit circuitry to the first channel may include controlling the multiplexer to couple a driver of the transmit circuitry to a first terminal directly connected to the first channel. For example, the multiplexer such as a bus exchange multiplexer may be inserted between the driver and pin on both ends in silicon with nothing in between. In another embodiment, the first channel and the second channel may include a first set of channels and a second set of channels, and the first set of channels and the second set of channels are coupled by an I/O switch based on the transmit path and the receive path. The first channel and the second channel may include a variable complex channel, multiple boards, or multiple cables. In certain embodiments, the transmit circuitry and the receive circuitry may be included in a large single circuit or separate circuits.

The method 200 illustrates a method for a controller to perform a channel input/output (I/O) swap. The I/O swap may be implemented before link training or changed during training to configure a channel configuration determined to have better signal integrity. The method 200 may be implemented logic in the controller that may performs the I/O swap to prevent system instability using the multiplexer, a cross bar, or other component. One advantage of embodiments the system is that the system may determine the I/O swap before link training to avoid a potential driver contention. In some embodiments, the I/O swap may be implemented during initialization or during link repurposing after initialization when the controller may perform a break-before-make order to prevent system instability. This may be used to prevent two drivers from driving the same channel, leading to channel contentions and loss of data. The muxes may be set to a safe setting (e.g., with each TX connected to a RX) before link training starts. In a break-before-make operation, the connects from muxes to channels are disconnected first, then reconnected after an I/O swap with the desired mux setting. This may reduce the likelihood of more than one driver on a channel at any time.

The controller may be the basic input/output system (BIOS) or the baseband management controller (BMC) of an information handling system (IHS) with logic included to perform the channel configuration determination and/or execute the I/O swap. In some embodiments, the basic input/output system (BIOS) may be included in the link training sequence and control the I/O swap and the baseband management controller (BMC). For example, the basic input/output system (BIOS) may swap the channels to change to a different channel configuration. In some embodiments, the baseband management controller (BMC) may be included in the link training sequence and control the I/O swap and the basic input/output system (BIOS). In other embodiments, the controller may be a complex programmable logic device (CPLD) or other processor or logic circuitry. When the basic input/output system (BIOS), basic management controller (BMC), or another controller directs the I/O swap. In some embodiments, the logic may be embedded on a daughter card, an add-in card such as a PCIe CEM adapter, or an Open Computer Project network interface card (OCP NIC) 3.0 adapter, or a Non-Volatile Memory Express (NVMe) drive in a U.2 or E.3 drive form factor.

Regarding method 200 and other embodiments disclosed, other steps and methods may be conceived that are equivalent in function, logic, or effect to one or more steps, or portions thereof, of the disclosed method. Additionally, the order in which a particular method occurs may or may not strictly adhere to the order of the correspond steps as described. In some embodiments, the method may be implemented in a computer readable medium, an algorithm and/or programmable rules. For example, the programmable rules and/or algorithm such as a machine learning algorithm may provide steps for the controller to implement to control the multiplexer at a lane-level granularity. The controller may independently control the multiplexer and the channel swaps to find an optimized channel for the transmit and receive signals at block 206. For example, independently controlling the multiplexer may allow the controller to determine the channel configuration mapping based on the figure of merit from block 202 to identify adequate channel margins at block 204. The algorithm may occur in auxiliary mode, during boot up before the PCI enumeration phase, or at another time. The timing of the I/O swap may be designed to account for different systems. When the device coupled to the interface reaches normal operating temperature, the system may change, and identifying a figure of merit such as the physical bit error rate, margin reads, secret registers, or other merit may indicate a system issue.

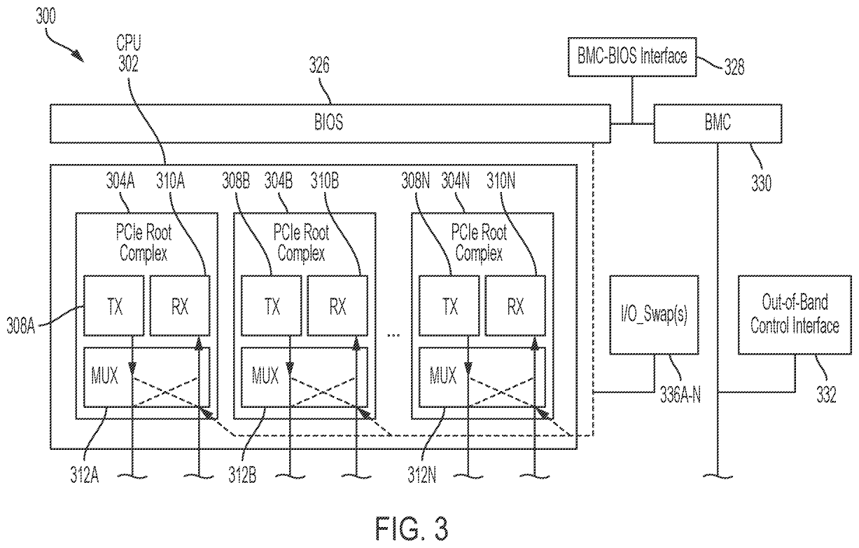

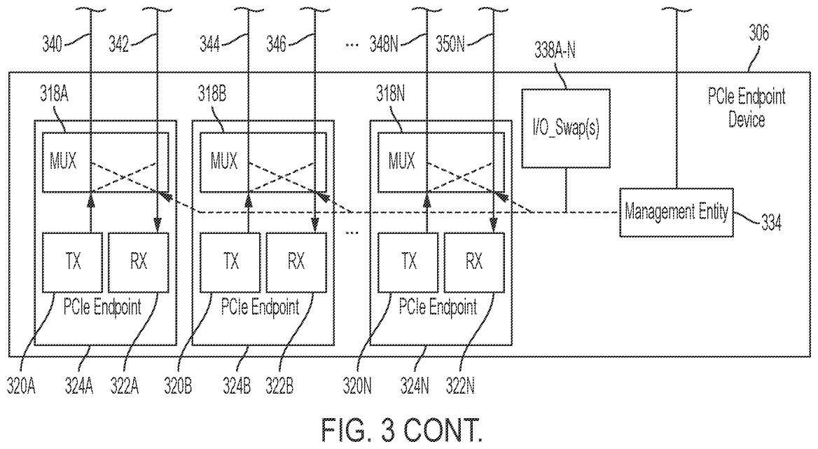

FIG. 3 depicts a block diagram of an apparatus such as an information handling system 300 that may implement method 200. The information handling system 300 may include a peripheral component interface (PCI) bus that may include a plurality of channels such a PCI channel 340, PCI channel 342, PCI channel 344, PCI channel 346, PCI channel 348N, and PCI channel 350N. For example, the PCI bus may include x1 connections to endpoints 342A-N as shown in FIG. 3, but may also include other configurations such as x4, x8, or x16 PCIe connections. The PCI bus may be connected between a central processing unit (CPU) 302 and a PCIe endpoint device 306. Communications between the endpoint devices, such as the PCIe endpoint device 306, and the CPU 302 may be sensitive to characteristics of the channels 340-350N due to channel parasitics or system noise resulting from the layout of the channels 340-350N from the CPU 302 and endpoint device 306 (e.g., routing positions and physical characteristics of the routing through a printed circuit board). For example, the system may consider various figures of merit, such as the margins or signal-to-noise ratio (SNR) of the channels 340-350N, in determining a channel configuration for instructing multiplexers, such as instructing MUX 312A to swap the PCI channels 340 and/or 342.

The upstream and downstream ports may include an inbuilt multiplexer (MUX). For example, an upstream PCIe root complex 304A may include a MUX 312A, and a downstream port PCIe endpoint 324A may include a MUX 318A. In some embodiments, the information handling system 300 may include an upstream PCIe root complex 304B with a MUX 312B, a downstream port PCIe endpoint 324B with a MUX 318B, an upstream PCIe root complex 304N with a MUX 312N, a downstream port PCIe endpoint 324N with a MUX 318N. In some embodiments, the MUX 312A, MUX 318A, MUX 312B, MUX 318B, MUX 312N, and/or MUX 318N may be coupled to the PCI bus and may be configured to couple transmit circuitry to the PCI channel mapped as a transmit path in a channel configuration. For example, MUX 312A may be configured to couple TX circuitry 308A to PCI channel 340 or PCI channel 342 mapped as the transmit path to RX circuitry 322A in different channel configurations. Additionally, MUX 312B may be configured to couple TX circuitry 308B to PCI channel 344 or PCI channel 346 mapped as the transmit path to RX circuitry 322B, and MUX 312B may be configured to couple TX circuitry 308N to PCI channel 348N or PCI channel 350N mapped as the transmit path to RX circuitry 322N. The transmit path may also originate from downstream. For example, the MUX 318A may be configured to couple TX circuitry 320A to PCI channel 340 or PCI channel 342 mapped as the transmit path to RX circuitry 310A according to different channel configurations. That is, one available channel configurations for mux 312A may include TX/RX circuitry 308A/310A coupled to PCI channels 340/342, respectively, and another available channel configuration for mux 312A may include TX/RX circuitry 308A/310A coupled to PCI channels 342/340, respectively. The MUX 312A, MUX 318A, MUX 312B, MUX 318B, MUX 312N, or MUX 318N may also be configured to couple receive circuitry to the PCI channel mapped as a receive path in a channel configuration. For example, MUX 318A may be configured to couple RX circuitry 322A to PCI channel 340 or PCI channel 342 mapped as the receive path to TX circuitry 308A. In some embodiments, the MUX 312A, MUX 318A, MUX 312B, MUX 318B, MUX 312N, or MUX 318N may include an internal whole SerDes interface type MUX, which may provide interface options such as PCIe, Serial Advanced Technology Attachment (SATA), 10 gigabit media-independent interface (XGMII), unified payment interface (UPI), universal serial bus 3.0 (USB3), or other interface types. In some embodiments, some or all of the channels 340-350N may be other channel types such as SATA channels, XGMII channels, UPI channels, USB3 channels, or other channels. PCI channels 340, 342, 344, 346, 348N, or 350N may also include a first set of channels and a second set of channels coupled by an I/O switch based on the transmit path and the receive path.

In another embodiment, the PCI channels 340, 342, 344, 346, 348N, and/or 350N may include multiple boards, cables, or other comparable components. The information handling system may determine the channel configuration based on a priori knowledge of the conditions of the channels 340-350N. For example, the information may include self-describing attributes of each board, cable, and connector throughout the channel, such as known resistance of the channel, known usable frequencies of the channel, whether the channel is a conductive trace or a wire, etc.

A BMC-BIOS interface 328 for communications between the BIOS 326 and the BMC 330 may allow the BIOS 326 or the BMC 330 to implement the I/O swap logic. For implementing the logic, the information handling system 300 may include a memory and a processor, such as the BIOS 326 or the BMC 330. The BIOS 326 may be configured with an in-band communications to the management entity 334 that may cause the management entity 334 to send certain I/O_{—} Swap signals 336A-N. In some embodiments, the BMC 330 may be configured with out-of-band communications to the BIOS 326 that may provide control over the I/O_Swap signals 338A-N by communicating with the management entity 334 using the out-of-band interface 332. The I/O_Swap signals 336A-N and 338A-N may instruct MUX 312A, MUX 318A, MUX 312B, MUX 318B, MUX 312N, or MUX 318N to couple the transmit circuitry, such as TX 320B, to receive circuitry, such as RX 310B, for the transmit path. The I/O_Swap signals 336A-N and 338A-N may instruct MUX 312A, MUX 318A, MUX 312B, MUX 318B, MUX 312N, or MUX 318N to couple the receive circuitry to the transmit circuitry, such as TX 320N, as a receive path. In some embodiments, the transmit circuitry and the receive circuitry may be included in a large single circuit or separate circuits. In some embodiments, the in-band communications may include PCI configuration space, or management component transport protocol (MCTP) over a system management bus (SMBUS) or via a vital product data (VPD) element that are in chain with the PCI channels.

The information handling system 300 may determine the channel configuration mapping and accordingly control I/O_Swap signals 336A-N or 338A-N. In certain embodiments, the BIOS 326 is the controller, the BIOS 326 may determine a figure of merit of at least one channel of the N channels of the PCI bus. In some embodiments, the figure of merit may include a physical bit error rate, a margin measurement, a signal timing, a signal-to-noise ratio (SNR), a bathtub measurement, or an Eye-diagram characteristic. An Eye-diagram characteristic may include signal timing, signal levels, and a measurement between differential pairs to predict headroom before failure. In another embodiment, the BIOS 326 may identify netlist and static attributes of each signal and/or medium throughout the channel by collecting and analyzing attributes before the channel links are purposed or during the BIOS 326 training phase with lane direction swaps occurring within to find the optimized channel configuration. In some embodiments, the BIOS 326 may identify medium characteristics, for use in determining the channel configuration, including silicon design, layers, length, connector rows, or cable pinouts or may identify another characteristic of the channel such as the receiver sensitivity, another sensitivity, or a channel capabilities in-band.

After determining the figure of merit, the BIOS 326 may determine the channel configuration mapping transmit and receive paths to the plurality of N channel of the PCI bus. Then, BIOS 326 may control the MUX 312A, MUX 312B, or MUX 312N to implement I/O_Swap signals 336A-N. For example, MUX 312B may toggle based on the I/O_Swap signals 336A-N for coupling the transmit circuitry such as TX 308B to the PCI channel 344 or PCI channel 346. The BIOS 326 may also control the BMC 330 using the BMC-BIOS interface 328 to communicate with the management entity 334 through the out-of-band control interface 332. The management entity 334 may control the downstream MUX 318A, MUX 318B, or MUX 318N. For example, management entity 334 may instruct MUX 318B using I/O_Swap signals 338A-N for coupling the transmit circuitry such as TX 308B through PCI channel 344 or PCI channel 346 to RX 322B as the transmit path. In certain embodiments, the BIOS 326 may control the MUX 312A, MUX 312B, or MUX 312N to couple a driver of the transmit circuitry to a terminal directly connected to a PCI channel. The multiplexers such as MUX 312A, MUX 312B, or MUX 312N may be inserted between the driver and pin on both ends in silicon with nothing in between.

The BIOS 326 may determine the information handling system 300 elements connected to the PCI bus, the BMC-BIOS interface 328, and/or the out-of-band control interface 332 as part of determining the channel configuration. The types of endpoint devices connected to various channels may be used in determining a channel configuration, such as to prioritize uplink signal quality or downlink signal quality for certain endpoint devices.

In another embodiment, the BMC 330 is the controller, the BMC 330 may determine the figure of merit of at least one channel of the N channels of the PCI bus. In another embodiment, the BMC 330 may identify netlist and static attributes of each signal and/or medium through the channel by collecting and analyzing attributes before the channel links are purposed or during the BIOS 326 training phase. In some embodiments, the BMC 330 may identify medium characteristics such as silicon design, layers, length, connector rows, or cable pinouts or may identify another characteristic of the channel such as the receiver sensitivity, another sensitivity, or a channel capabilities in-band. For example, the channel capabilities out-of-band may include PCI configuration space, or management component transport protocol (MCTP) over a system management bus (SMBUS) or via a vital product data (VPD) element.

After determining the figure of merit, the BMC 330 may determine the channel configuration mapping transmit and receive paths to the plurality of N channel of the PCI bus. Then, BMC 330 may control with the management entity 334 through the out-of-band control interface 332, the MUX 318A, MUX 318B, or MUX 318N using I/O_Swap signals 338A-N. For example, management entity 334 may instruct MUX 318N to control I/O_Swap signals 338A-N for coupling the receive circuitry such as RX 310N through the PCI channel 348N or PCI channel 350N to TX 308N as the receive path. In certain embodiments, the BMC 330 may control the MUX 318A, MUX 318B, or MUX 318N to couple a driver of the transmit circuitry to a terminal directly connected to the PCI channel. The multiplexers, such as MUX 318A, MUX 318B, or MUX 318N, may be inserted between the driver and pin on both ends in silicon as a direct connection from the mux to the pin. In another embodiment, the MUX 318B may also control I/O_Swap signals 338A-N for coupling the transmit circuitry such as TX 320N to the PCI channel 348N or PCI channel 350N. In some embodiments, the BMC 330 may control the BIOS 326 using the BMC-BIOS interface 328 by determining the channel configuration and instructing BIOS 326 and management entity 334 to control I/O swap signals to implement the determined channel configuration.

By independently controlling the MUX 312A, MUX 312B, MUX 312N, MUX 318A, MUX 318B, or MUX 318N, the information handling system 300 may optimize a channel configuration for the transmission and/or receipt of information based on one or more of figure of merits (e.g., SNR) of the channels, the types of endpoints (e.g., GPU, CPU, NIC, storage), and/or physical characteristics of the channels (e.g., number of layers spanned by the channel, distance of conductor in the channel, type of conductor of the channel).

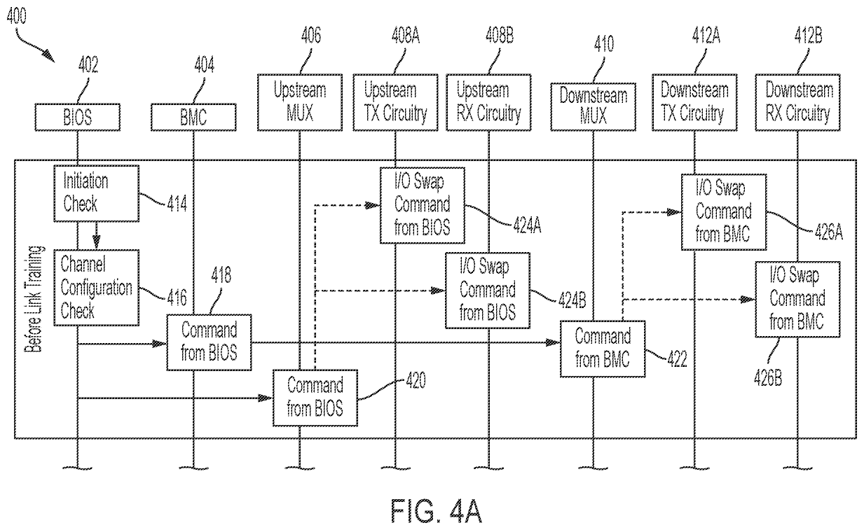

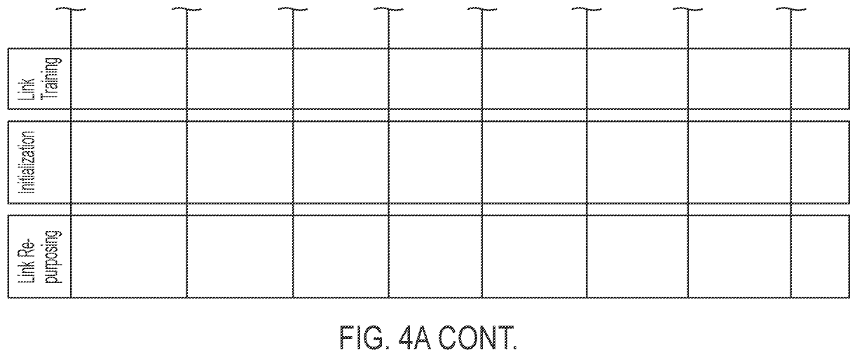

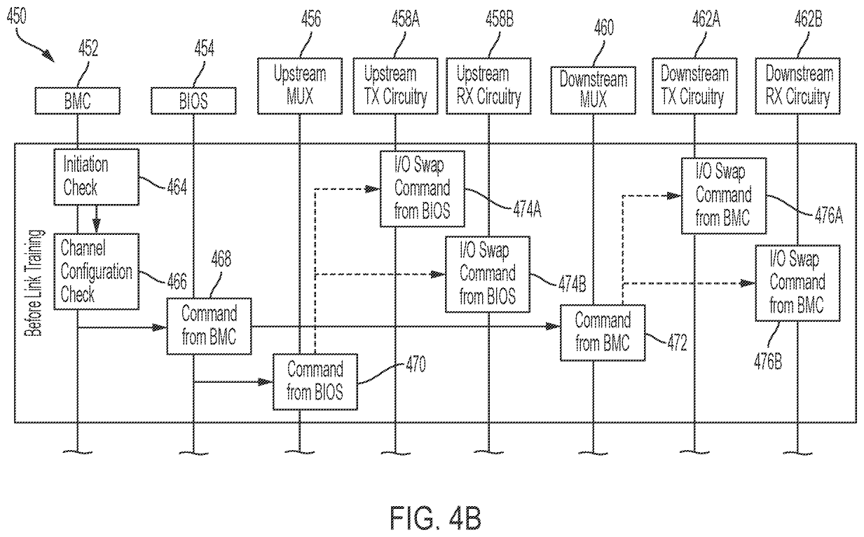

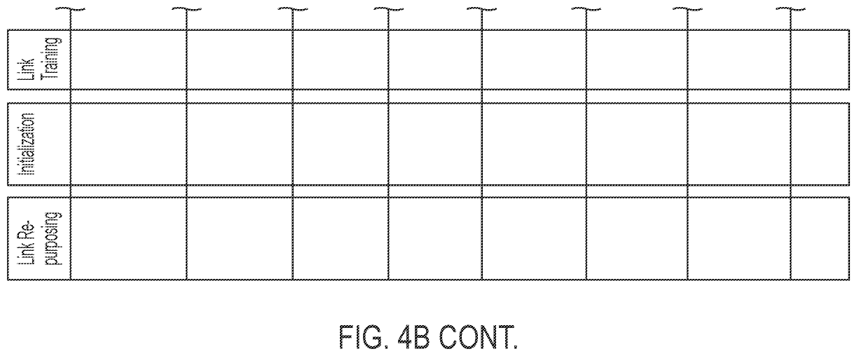

In some embodiments, the I/O Swap 336A-N and/or I/O Swap 338A-N may be implemented before link training as shown in FIGS. 4A and 4B. FIGS. 4A and 4B depict a sequence flow diagram of the present invention according to some embodiments. Link training may include initialization or link purposing, and links may be re-purposed after initialization and during operation. A controller such as BIOS 402 or BMC 404 may implement the I/O swap commands before link training, during link training, during initialization, or during link re-purposing to find the optimal channel configuration.

In FIG. 4A, the BIOS 402 is the controller in the sequence flow 400, and during link training, the BIOS 402 may implement an initiation check 414. For example, the BIOS 402 may determine whether the BIOS 402 and/or the BMC 404 may control an upstream MUX 406 and/or a downstream MUX 410. In some embodiments, the BIOS 402 may identify the components in the system such as the multiplexers, memory, management entity, and/or interfaces. Before the system implements the I/O swap logic, the BIOS 402 may also determine the channel configuration using a channel configuration check 416. The channel configuration check 416 may include the channel configuration mapping based on a figure of merit of at least one channel of a plurality of channels of an interface. The figure of merit may include a physical bit error rate, a margin measurement, a signal timing, a signal-to-noise ratio (SNR), a bathtub measurement, or an Eye-diagram characteristic. An Eye-diagram characteristic may include signal timing, signal levels, and a measurement between differential pairs to predict headroom before failure. In another embodiment, the BIOS 402 may identify netlist and static attributes of each signal and/or medium throughout the channel by collecting and analyzing attributes before the channel links are purposed or during the BIOS 402 training phase with lane direction swaps occurring within to find the optimized channel configuration. In some embodiments, the BIOS 402 may identify medium characteristics such as silicon design, layers, length, connector rows, or cable pinouts or may identify another characteristic of the channel such as the receiver sensitivity, another sensitivity, or a channel capabilities in-band. For example, the channel capabilities may include PCI configuration space, or management component transport protocol (MCTP) over a system management bus (SMBUS) or via a vital product data (VPD) element.

The BIOS 402 may determine a channel configuration mapping a transmit path and a receive path for the plurality of channels of the interface based on the figure of merit and may send command 418 to the BMC 404 and command 420 to the upstream MUX 406. Command 418 may instruct BMC 404 to send command 418 to the downstream MUX 410 to couple the downstream TX circuitry 412A to the channel mapped as the transmit path using an I/O Swap command 426A. Command 418 may also instruct the downstream MUX 410 to couple the downstream RX circuitry 412B to the channel mapped as the receive path using an I/O Swap command 426B. Command 420 may instruct the upstream MUX 406 to implement I/O swap command 424A and/or 424B for coupling the upstream TX circuitry 408A and/or upstream RX circuitry 408B to a channel to configure a transmit and/or receive path, respectively. In some embodiments, the BIOS 402 may control with another comparable controller or management device. In some embodiments, the BIOS 402 may control the upstream MUX 406 and/or the downstream MUX 410 to couple a driver of the transmit circuitry to a terminal directly connected to one of the channels of the interface.

The BIOS 402 may control the upstream MUX 406, the downstream MUX 410, and/or the BMC 404 to independently alter the channel swaps through any number of algorithms. In one example, the BIOS 402 may walk each channel through each lane direction while performing measurements on the channels to discover an optimal signal integrity before or after link training and determining a channel configuration based on the lane tests. In another example, the BIOS 402 may use a trained machine learning (ML) by inputting information (e.g., measurement of figures of merits, device information, and/or channel physical characteristics) to the ML model and determining a channel configuration based on the ML model.

In FIG. 4B, the BMC 452 is the controller in the sequence flow 450, and during link training, the BMC 452 may implement an initiation check 464. For example, the BMC 452 may determine whether a root complex and/or endpoint support I/O swap operations. In some embodiments, the BMC 452 may identify the components in the system such as the multiplexers, memory, management entity, interfaces. Before the system performs I/O swap operations, the BMC 452 may determine the channel configuration using a channel configuration check 466. The channel configuration check 466 may include determining a channel configuration by mapping based on a figure of merit of at least one channel of a plurality of channels of an interface. The figure of merit may include a physical bit error rate, a margin measurement, a signal timing, a signal-to-noise ratio (SNR), a bathtub measurement, or an Eye-diagram characteristic. An Eye-diagram characteristic may include signal timing, signal levels, and a measurement between differential pairs to predict headroom before failure. In some embodiments, the BMC 452 may identify netlist and static attributes of each signal and/or medium throughout the channel by collecting and analyzing attributes before the channel links are purposed or during the BIOS 454 training phase. In some embodiments, the BMC 452 may identify medium characteristics such as silicon design, layers, length, connector rows, or cable pinouts or may identify another characteristic of the channel such as the receiver sensitivity, another sensitivity, or a channel capabilities in-band. For example, the channel capabilities may include PCI configuration space, or management component transport protocol (MCTP) over a system management bus (SMBUS) or via a vital product data (VPD) element.

The BMC 452 may determine a channel configuration mapping a transmit path and a receive path for the plurality of channels of the interface based on the figure of merit and may send command 468 to the BIOS 454 and command 472 to the downstream MUX 460. Command 468 may instruct BIOS 454 to send command 470 to the upstream MUX 456 to couple the upstream TX circuitry 458A to the channel mapped as the transmit path using an I/O Swap command 474A. Command 470 may also instruct the upstream MUX 456 to couple the upstream RX circuitry 458B to the channel mapped as the receive path using an I/O Swap command 474B.

In some embodiments, the BMC 452 may control with the management entity through an out-of-band control interface. For example, the management entity may receive instructions from BMC 452 and instruct the downstream MUX 460 to implement I/O Swap command 476A and/or 476B for coupling the downstream TX circuitry 462A and/or downstream RX circuitry 462B, respectively. In another embodiment, the BMC 452 may control the upstream MUX 456 and/or the downstream MUX 460 to couple a driver of the transmit circuitry to a terminal directly connected to one of the channels of the interface. The BMC 452 may control the upstream MUX 456, the downstream MUX 460, and/or the BIOS 454 to independently alter the channel swaps through algorithms such as those described above.

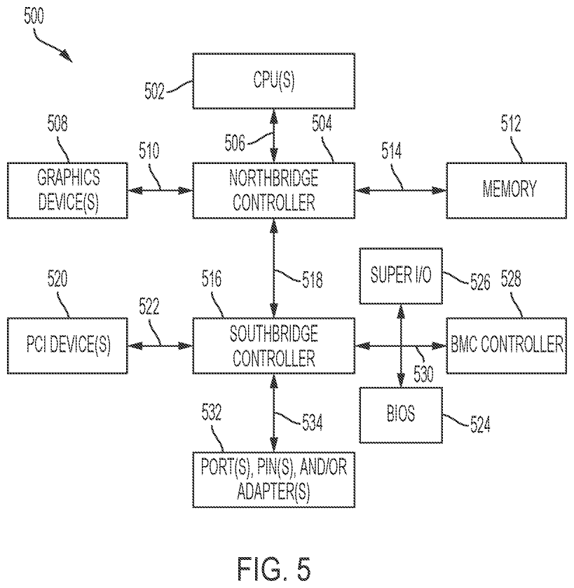

An information handling system may include a variety of components to generate, process, display, manipulate, transmit, and receive information. Any of the illustrated components may be coupled to each other by a cable, such as embodiments of a cable described in this disclosure. One example of an information handling system 500 is shown in FIG. 5. IHS 500 may include one or more central processing units (CPUs) 502. In some embodiments, IHS 500 may be a single-processor system with a single CPU 502, while in other embodiments IHS 500 may be a multi-processor system including two or more CPUs 502 (e.g., two, four, eight, or any other suitable number). CPU(s) 502 may include any processor capable of executing program instructions. For example, CPU(s) 502 may be processors capable of implementing any of a variety of instruction set architectures (ISAs), such as the x86, POWERPC®, ARM®, SPARC®, or MIPS® ISAs, or any other suitable ISA. In multi-processor systems, each of CPU(s) 502 may commonly, but not necessarily, implement the same ISA.

CPU(s) 502 may be coupled to northbridge controller or chipset 504 via front-side bus 506. The front-side bus 506 may include multiple data links arranged in a set or bus configuration. Northbridge controller 504 may be configured to coordinate I/O traffic between CPU(s) 502 and other components. For example, northbridge controller 504 may be coupled to graphics device(s) 508 (e.g., one or more video cards or adaptors, etc.) via graphics bus 510 (e.g., an Accelerated Graphics Port or AGP bus, a Peripheral Component Interconnect or PCI bus, etc.). Northbridge controller 504 may also be coupled to system memory 512 via memory bus 514. Memory 512 may be configured to store program instructions and/or data accessible by CPU(s) 502. In various embodiments, memory 512 may be implemented using any suitable memory technology, such as static RAM (SRAM), synchronous dynamic RAM (SDRAM), non-volatile/Flash-type memory, or any other type of memory.

Northbridge controller 504 may be coupled to southbridge controller or chipset 516 via internal bus 518. Generally, southbridge controller 516 may be configured to handle various of IHS 500's I/O operations, and it may provide interfaces such as, for instance, Universal Serial Bus (USB), audio, serial, parallel, Ethernet, etc., via port(s), pin(s), and/or adapter(s) 532 over bus 534. For example, southbridge controller 516 may be configured to allow data to be exchanged between IHS 500 and other devices, such as other IHSs attached to a network. In various embodiments, southbridge controller 516 may support communication via wired or wireless general data networks, such as any suitable type of Ethernet network, via telecommunications/telephony networks such as analog voice networks or digital fiber communications networks, via storage area networks such as Fiber Channel SANs, or via any other suitable type of network and/or protocol.

Southbridge controller 516 may also enable connection to one or more keyboards, keypads, touch screens, scanning devices, voice or optical recognition devices, or any other devices suitable for entering or retrieving data. Multiple I/O devices may be present in IHS 500. In some embodiments, I/O devices may be separate from IHS 500 and may interact with IHS 500 through a wired or wireless connection. As shown, southbridge controller 516 may be further coupled to one or more PCI devices 520 (e.g., modems, network cards, sound cards, video cards, etc.) via PCI bus 522. The PCI devices 520 may couple to other information handling systems (such as through network cabling) and electronic devices (such as through audio cabling), in which the coupling is through wires according to embodiments of this disclosure. Southbridge controller 516 may also be coupled to Basic I/O System (BIOS) 524, Super I/O Controller 526, and Baseboard Management Controller (BMC) 528 via Low Pin Count (LPC) bus 530.

BIOS 524 may include non-volatile memory having program instructions stored thereon. The instructions stored on the BIOS may be usable CPU(s) 502 to initialize and test other hardware components and/or to load an Operating System (OS) onto IHS 500, for example during a pre-boot stage. For example, BIOS may also refer to a set of instructions, stored on BIOS 524, that are executed by CPU(s) 502. As such, BIOS 524 may include a firmware interface that allows CPU(s) 502 to load and execute certain firmware, as described in more detail below. In some cases, such firmware may include program code that is compatible with the Unified Extensible Firmware Interface (UEFI) specification, although other types of firmware may be used.

BMC controller 528 may include non-volatile memory having program instructions stored thereon that are usable by CPU(s) 502 to enable remote management of IHS 500. For example, BMC controller 528 may enable a user to discover, configure, and manage BMC controller 528, setup configuration options, resolve and administer hardware or software problems, etc. Additionally or alternatively, BMC controller 528 may include one or more firmware volumes, each volume having one or more firmware files used by the BIOS' firmware interface to initialize and test components of IHS 500.

In some embodiments, IHS 500 may be configured to access different types of computer-accessible media separate from memory 512. Generally speaking, a computer-accessible medium may include any tangible, non-transitory storage media or memory media such as electronic, magnetic, or optical media—e.g., magnetic disk, a hard drive, a CD/DVD-ROM, a Flash memory, etc. coupled to IHS 500 via northbridge controller 504 and/or southbridge controller 516. Super I/O Controller 526 combines interfaces for a variety of lower bandwidth or low data rate devices. Those devices may include, for example, floppy disks, parallel ports, keyboard and mouse, temperature sensor and fan speed monitoring, etc.

In some embodiments, northbridge controller 504 may be combined with southbridge controller 516, and/or be at least partially incorporated into CPU(s) 502. In other implementations, one or more of the devices or components shown in FIG. 5 may be absent, or one or more other components may be added. Accordingly, systems and methods described herein may be implemented or executed with other computer system configurations. In some cases, various elements shown in FIG. 5 may be mounted on a motherboard, coupled to a PCB, paddleboard or other connector, or protected by a chassis or the like.

The schematic flow chart and sequence flow diagrams of FIG. 2, FIG. 4A, and FIG. 4B are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as Adaboost or stochastic gradient boosting systems for iteratively updating weighting to train a machine learning classifier to determine a relationship between an influencing attribute, such as received channel configuration data, and a system or a transmit path or a receive path and/or a degree to which such an influencing attribute affects the outcome of such a system or the transmit path or the receive path.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuity may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although communication channels are described throughout the detailed description, aspects of the disclosure may be applied to the design of or implementation on different kinds of channels, such as buses, variable complex channels, cables, or chips. As another example, although communications and transmissions of certain signals through the channels may be described in example embodiments, other kinds or types of information may be carried through the channels depending on applications and operations performed by the information handling system using the channel configurations. As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of non-volatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

What is claimed is:

1. A method, comprising:
determining, by an information handling system, a first figure of merit of at least one channel of a plurality of channels coupled to an interface;
determining, by the information handling system based on the first figure of merit, a channel configuration mapping transmit and receive paths to the plurality of channels of the interface; and
controlling, by the information handling system based on the channel configuration, a multiplexer to couple transmit circuitry to a first channel mapped as a transmit path in the channel configuration and to couple receive circuitry to a second channel mapped as a receive path in the channel configuration.

2. The method of claim 1, wherein the controlling the multiplexer to couple transmit circuitry to the first channel comprises controlling the multiplexer to couple a driver of the transmit circuitry to a first terminal directly connected to the first channel.

3. The method of claim 1, wherein the controlling the multiplexer to couple transmit circuitry to the first channel and to couple receive circuitry to the second channel is performed before link training.

4. The method of claim 1, wherein the controlling the multiplexer to couple transmit circuitry to the first channel and to couple receive circuitry to the second channel is performed by a basic input/output system (BIOS) of the information handling system, the method further comprising: controlling, by the BIOS through a baseboard management controller (BMC) of the information handling system, a second multiplexer at an endpoint device coupled to the first channel and the second channel based on the channel configuration.

5. The method of claim 4, wherein the controlling the multiplexer by the BIOS comprises controlling a multiplexer coupling a central processing unit (CPU) to the first channel and the second channel, and wherein controlling the second multiplexer by the BMC comprises controlling a peripheral component interconnect express (PCIe) device.

6. The method of claim 1, wherein determining the channel configuration mapping transmit and receive paths to the plurality of the channels of the interface based on the first figure of merit comprises determining the channel configuration mapping transmit and receive paths to the plurality of the channels of the interface based on at least one of a physical bit error rate, a margin measurement, a signal timing, a signal-to-noise ratio (SNR), a bathtub measurement, an Eye-diagram characteristics, or a sensitivity of the first channel.

7. An apparatus, comprising:
an interface configured to couple to a plurality of channels;
a multiplexer coupled to the interface and configured to couple transmit circuitry to a first channel mapped as a transmit path in a channel configuration and to couple receive circuitry to a second channel mapped as a receive path in the channel configuration; and
a controller coupled to the multiplexer, wherein the controller is configured to perform steps comprising:
determining, by an information handling system, a first figure of merit of at least one channel of a plurality of channels coupled to an interface;
determining, by the information handling system based on the first figure of merit, a channel configuration mapping transmit and receive paths to the plurality of channels of the interface; and
controlling, by the information handling system based on the channel configuration, a multiplexer to couple transmit circuitry to a first channel mapped as a transmit path in the channel configuration and to couple receive circuitry to a second channel mapped as a receive path in the channel configuration.

8. The apparatus of claim 7, wherein the controlling the multiplexer to couple transmit circuitry to the first channel comprises controlling the multiplexer to couple a driver of the transmit circuitry to a first terminal directly connected to the first channel.

9. The apparatus of claim 7, wherein determining the channel configuration mapping transmit and receive paths to the plurality of the channels of the interface based on the first figure of merit comprises determining the channel configuration based on at least one of a physical bit error rate, a margin measurement, a signal timing, a signal-to-noise ratio (SNR), a bathtub measurement, an eye-diagram characteristics, or a sensitivity of the first channel.

10. The apparatus of claim 7, wherein the first channel and the second channel comprise a first set of channels and a second set of channels, wherein the first set of channels and the second set of channels are coupled by an I/O switch based on the transmit path and the receive path.

11. The apparatus of claim 7, wherein the interface comprises a package terminal array.

12. The apparatus of claim 7, wherein the controller is configured to perform the controlling the multiplexer to couple transmit circuitry to the first channel and to couple receive circuitry to the second channel is performed before link training.

13. The apparatus of claim 7, wherein the controller is a basic input/output system (BIOS), wherein the basic input/output system (BIOS) is configured to control a baseband management controller (BMC) to control a second multiplexer at an endpoint device coupled to the interface through the first channel and the second channel.

14. The apparatus of claim 13, wherein the apparatus comprises a central processing unit (CPU), and wherein the BIOS is configured to control the BMC to control the second multiplexer at a peripheral component interconnect express (PCIe) device.

15. An information handling system, comprising:
a peripheral component interface (PCI) bus comprising a plurality of channels;
a memory; and
a processor coupled to the memory and comprising a multiplexer coupled to the peripheral connection (PCI) interface bus and configured to couple transmit circuitry to a first channel mapped as a transmit path in a channel configuration and to couple receive circuitry to a second channel mapped as a receive path in the channel configuration,
wherein the processor is configured to perform steps comprising:
determining, by an information handling system, a first figure of merit of at least one channel of the plurality of channels;
determining, by the information handling system based on the first figure of merit, a channel configuration mapping transmit and receive paths to the plurality of channels; and
controlling, by the information handling system based on the channel configuration, a multiplexer to couple transmit circuitry to a first channel mapped as a transmit path in the channel configuration and to couple receive circuitry to a second channel mapped as a receive path in the channel configuration.

16. The information handling system of claim 15, wherein controlling the multiplexer to couple transmit circuitry to the first channel comprises controlling the multiplexer to couple a driver of the transmit circuitry to a first terminal directly connected to the first channel.

17. The information handling system of claim 15, wherein determining the channel configuration mapping transmit and receive paths to the plurality of the channels based on the first figure of merit comprises determining the channel configuration mapping transmit and receive paths to the plurality of the channels based on at least one of a physical bit error rate, a margin measurement, a signal timing, a signal-to-noise ratio (SNR), a bathtub measurement, an eye-diagram characteristics, or a sensitivity of the first channel.

18. The information handling system of claim 15, controlling the multiplexer to couple transmit circuitry to the first channel and to couple receive circuitry to the second channel is performed before link training.

19. The information handling system of claim 15, further comprising a basic input/output system (BIOS) coupled to the processor, wherein the controlling the multiplexer to couple transmit circuitry to the first channel and to couple receive circuitry to the second channel is performed by a basic input/output system (BIOS) of the information handling system.

20. The information handling system of claim 19, further comprising an endpoint device comprising a second multiplexer and coupled to the PCI bus through the second multiplexer; and a baseband management controller (BMC) coupled to the BIOS and to the endpoint device, wherein the basic management controller (BMC) is configured to control the second multiplexer based on the channel configuration.
